(19) United States
(12) Patent Application Publication
(10) Pub. No.: US 2025/0078490 A1
(43) Pub. Date: Mar. 6, 2025

(54) METHOD OF DETERMINING AN ARRANGEMENT FOR OBJECTS

(71) Applicant: Imperial College Innovations Limited, London (GB)

(72) Inventors: Ivan KAPELYUKH, London (GB); Edward JOHNS, London (GB)

(21) Appl. No.: 18/951,088

(22) Filed: Nov. 18, 2024

Related U.S. Application Data
(63) Continuation of application No. PCT/GB2023/051470, filed on Jun. 6, 2023.

(30) Foreign Application Priority Data
Jun. 7, 2022 (GB) 2208343.0

(51) Int. Cl. G06V 10/82; G06T 1/00; G06V 20/70

(52) U.S. Cl. CPC G06V 10/82; G06T 1/0014; G06V 20/70

(57) ABSTRACT

A method of determining an arrangement for objects comprises obtaining first data representing a first arrangement of first objects in a scene; inputting the obtained first data into a trained machine learning model to determine a first cost value for the first arrangement. The first cost value is indicative of an extent to which the first arrangement differs from an optimum arrangement of the first objects according to a cost function that the machine learning model has been trained to provide. The method comprises determining a second arrangement for the first objects based on the first cost value.

### CROSS-REFERENCE TO RELATED APPLICATIONS

This application is a continuation under 35 U.S.C. § 120 of International Application No. PCT/GB2023/051470, filed Jun. 6, 2023, which claims priority to GB Application No. GB 2208343.0, filed Jun. 7, 2022, under 35 U.S.C. § 119 (a). Each of the above-referenced patent applications is incorporated by reference in its entirety.

### TECHNICAL FIELD

The present invention relates to a method of determining an arrangement for objects.

### BACKGROUND

It may be desirable that a robot performs or assists with tasks, such as household tasks. Many such tasks involve the rearrangement of objects. For example, tidying a room, setting a table with cutlery and crockery, loading a dishwasher and stacking a fridge, are all tasks which involve placing certain objects in a certain or ‘correct’ arrangement. In order for a robot to complete such tasks, it can be important to determine a ‘correct’ arrangement in which objects are to be placed. However, this is challenging for robots or computers to do, as the ‘correct’ arrangement may involve a complex mixture of factors. Moreover, it may be desirable to determine such an arrangement in a flexible way, for example in a way that allows other factors to be considered, for example when controlling a robot to move the objects.

### SUMMARY

According to a first aspect of the invention, there is provided a method of determining an arrangement for objects, the method comprising: obtaining first data representing a first arrangement of first objects in a scene, the first data comprising data representing the first objects and data representing the relative pose between the first objects; inputting the obtained first data into a trained machine learning model to determine a first cost value for the first arrangement, the trained machine learning model having been trained to provide a cost function which, based on an input of data representing an arrangement of objects, outputs a cost value indicative of an extent to which the arrangement differs from an optimum arrangement, wherein the first cost value is indicative of an extent to which the first arrangement differs from an optimum arrangement of the first objects according to the cost function; and determining a second arrangement for the first objects based on the first cost value.

Determining the second arrangement for the first objects (e.g. an arrangement into which a robot is to tidy the first objects and/or e.g. an arrangement that is closer to a ‘tidy’ arrangement than is the first arrangement) based on a cost value indicative of an extent to which the first arrangement differs from an optimum arrangement (e.g. output from a learned ‘tidiness’ cost function of the machine learning model), may allow a flexible determination of the second arrangement. For example, this may provide for a more flexible determination as compared to predicting the optimal arrangement directly. For example, determining the second arrangement based on first cost value output by the cost function (e.g. a ‘tidiness’ cost function) may allow for combining this cost function with other cost functions (such as a time cost function) when determining the second arrangement, and/or may allow for one or more of the object positions to be fixed when determining the second arrangement. Accordingly, a flexible determination of the second arrangement may be provided for.

Optionally, the method comprises generating control instructions configured to cause a robot to move at least one of the first objects towards a pose that the at least one first object has in the second arrangement. This may allow a robot to change the arrangement of the objects, e.g. so that the arrangement is tidier. This may therefore allow for automated rearrangement, e.g. tidying of objects to be provided for.

Optionally, the method comprises: providing the control instructions to the robot to cause the robot to move at least one of the first objects towards a pose that the at least one first object has in the second arrangement. This may allow the objects in the scene to be placed in a tidier arrangement.

Optionally, determining the second arrangement comprises determining a second arrangement of the first objects that has a second cost value indicating that the second arrangement differs from the optimum arrangement to a lesser extent than the first arrangement. This may be determined by, for example, gradient descent and/or by sampling the cost function to identify such second arrangements. This may allow that the second arrangement is one which has a lower cost value than the first (initial) arrangement. Accordingly, this may allow that the second arrangement that is closer to an optimum of the cost function is provided for.

Optionally, determining the second arrangement comprises determining a gradient of the cost function at the first cost value. For example, following a descent of the determined gradient may allow for a second arrangement with a lower cost value than the first arrangement (e.g. a ‘tidier’ arrangement) to be automatically determined. In some examples, gradient descent may be applied only once or a few times to determine a second arrangement that has a cost value that is closer to a minimum of the cost function than the first arrangement. In some examples, gradient descent may be applied iteratively until a second arrangement at or near the minimum of the cost function is determined. In any case, determining the gradient may allow for the second arrangement to be determined in a relatively fast and resource efficient way.

Optionally, determining the second arrangement comprises determining a minimum of the cost function. For example, the second arrangement may be determined as one whose cost value is at or near a minimum (e.g. a local or a global minimum) of the cost function. This may, for example, help allow for a particularly tidy arrangement to be identified.

Optionally, determining the second arrangement comprises fixing the pose of one or more of the first objects of the first arrangement. For example, this may allow for physical constraints (such as objects that are large and hence cannot be moved) or user specified constraints (such as objects that a user does not wish to be moved) to be implemented when determining the second arrangement. This may, in turn, allow for a flexible determination of the second arrangement.

Optionally, determining the second arrangement based on the first cost value comprises: combining the first cost value with one or more further cost values for the first arrangement, thereby to generate a first combined cost value, the one or more further cost values each being determined from a respective further cost function and being indicative of a respective cost of the first arrangement as compared to a respective further optimum according to the respective further cost function; and determining the second arrangement based on the first combined cost value. This may provide that the cost function (e.g. the ‘tidiness’ cost function) is balanced with other costs, such as the time taken to produce a given arrangement and/or the extent to which some arrangements may not be possible because certain objects may not be placed in certain spaces. This may provide for flexible and practical determination of the second arrangement, and hence may, for example, provide for a flexible and practical implementation of a tidying robot.

Optionally, the one or more further cost values comprise one or more of: an occupancy cost value indicative of an extent to which one or more of the first objects in the first arrangement occupies a space that is not to be occupied; and a time cost value indicative of an estimate of a time it would take a robot to interact with one or more of the first objects in the first arrangement. The occupancy cost value may provide for physical practicalities or constraints of the objects and/or the scene to be incorporated into the determination of the second arrangement. For example, the occupancy cost value may be determined from an occupancy cost function which maps out in arrangement space cost values indicative of an extent to which one or more of the first objects in the first arrangement occupies a space that is not to be occupied. For example, a space not to be occupied may comprise a space in which a further object, or an immovable or fixed object of the first arrangement, is placed. As another example, a space not to be occupied may comprise a space for which it has been specified, e.g. by a user, that objects are not to be placed. As another example, as space not to be occupied may comprise a space in which an object would not be supported. The time cost value may provide for practicalities and constraints of the arrangements and/or the operation of the robot to be incorporated into the determination of the second arrangement. For example, the time cost value may be determined from a time cost function which maps out in arrangement space cost values indicative of a time that it will take the robot to interact with one or more of the first objects in the first arrangement. For example, the interaction may comprise reaching (including e.g. locomoting to and/or physically contacting) one or more of the first objects, engaging (e.g. grabbing or picking up) the one or more objects so that the one or more objects can be moved, and/or placing one or more objects in a certain position of a certain arrangement. In some examples, the time cost function may be minimum for minimum times. In some examples, the time cost function may reflect a time budget. For example, a robot may be given a certain amount of time to complete a task, and arrangements which would require more time for the robot to establish than the certain amount of time may be given a high time cost value, for example. Other further cost functions may be used. In any case, use of the further cost functions may provide for flexible and practical determination of the second arrangement

Optionally, determining the second arrangement comprises: determining a second arrangement that has a second combined cost value indicative of the second arrangement differing from a combination of the optimum arrangement and the respective further one or more optimums to a lesser extent that the first arrangement. For example, this may be determined by e.g. gradient descent and/or by sampling the combined cost function (that is, a combination of the cost function and the one or more further cost functions) to identify such second arrangements. This may allow that the second arrangement is one which has a lower combined cost value than the first (initial) arrangement. Accordingly, this may allow that the second arrangement that is closer to an optimum of the combined cost function is provided for.

Optionally, determining the second arrangement may comprise determining a gradient of a combined cost function at the first combined cost value, the combined cost function being a combination of the cost function and the one or more further cost functions. For example, following a descent of the determined gradient may allow for a second arrangement with a lower combined cost value than the first arrangement to be automatically determined. In some examples, gradient descent may be applied only once or a few times to determine a second arrangement that has a combined cost value that is closer to a minimum of the combined cost function than the first arrangement. In some examples, gradient descent may be applied iteratively until a second arrangement at or near the minimum of the combined cost function is determined. In any case, determining the gradient may allow for the second arrangement to be determined in a relatively fast and resource efficient way. This may provide, for example, a relatively fast and computationally efficient way to account for multiple costs when determining the second arrangement into which the objects are to be tidied.

Optionally, determining the second arrangement may comprise determining a minimum of a combined cost function, the combined cost function being a combination of the cost function and the one or more further cost functions. For example, the second arrangement may be determined as one whose combined cost value is at or near a minimum (e.g. a local or a global minimum) of the combined cost function. This may, for example, help allow for an arrangement which is particularly optimal in terms of a multiple of contributing costs to be identified.

Optionally, the obtained first data comprises first graph data representing a graph representing the first arrangement of objects in the scene, the graph comprising nodes and edges connecting nodes, wherein each node represents a respective object and each edge represents a relative pose between two objects represented by two nodes that the edge connects, wherein the trained machine learning model is a trained graph neural network having been trained to provide a cost function which, based on an input of graph data representing a graph representing an arrangement of objects, outputs a cost value indicative of an extent to which the arrangement differs from an optimum arrangement. The inventors have appreciated that a graph neural network may be well suited to learning object-object relations, and that, accordingly, providing the obtained first data as the first graph data, and using the graph neural network as the machine learning model, may provide for an efficient and/or reliable determination of the second arrangement.

Optionally, the first graph data comprises: for each node of the graph a semantic vector representative of the respective object; and/or for each edge of the graph a relative pose vector representative of the relative pose between two objects represented by two nodes that the edge connects. Having each node include semantic vector representative of the object may allow, for example, for the arrangements to be determined based on the type or nature of the objects. Alternatively, or additionally, this may allow for ‘new’ objects (where ‘new’ here is taken to mean objects on which the machine learning model has not been trained but which are e.g. semantically similar to objects on which the model has been trained) to be appropriately arranged. This may allow for the second arrangement to be determined flexibly (e.g. flexible with respect to the types of objects for which the method may be applied) and/or in a granular way (e.g. granular with respect to the type or nature of the objects in the arrangement).

Optionally, the method comprises: obtaining image data representing an image of the objects of the scene in the first arrangement; and generating the first data based on the obtained image data. This may allow for the second arrangement to be determined based on for example, a single image of the scene. This may allow for the second arrangement to be determined in a resource efficient way.

Optionally, generating the first graph data comprises: generating the semantic vector for each of the one or more objects; and/or generating a pose vector for each of the one or more objects, the pose vector representing a pose of each of the objects, and determining the relative pose vector for each edge based on the pose vector for the two objects of the two respective nodes that the edge connects. This may allow for the semantic vector and/or pose vectors to be generated from the obtained image. This may help allow for the method to be implemented autonomously.

Optionally, the method comprises training a machine learning model to provide the trained machine learning model, and wherein the training comprises: obtaining a training data set, the training data set comprising a plurality of sets of data, each set of data representing an arrangement of objects in a scene and comprising data representing the objects and data representing the relative pose between the objects, wherein each set of data representing an arrangement of objects is associated with a cost value label indicative of the extent to which the arrangement differs from an optimum arrangement of the objects; and training the machine learning model, based on the training data set, to provide a cost function which, based on an input of data representing an arrangement of objects, outputs a cost value indicative of an extent to which the arrangement differs from an optimum arrangement. This may allow for the trained machine learning model to be provided. For example, training the machine learning model may comprise optimising parameters of the model so as to minimise a loss between cost values predicted by the machine learning model for the arrangements of the training data set and the cost value labels of those arrangements. In some examples, optimising the parameters may comprise using maximum likelihood estimation. In some examples, the training data set may be generated from a set of images showing tidy arrangements. For example, the set of images may be obtained by performing a search, e.g. on the Internet, for tidy arrangements. For example, where the objects are cutlery and crockery of a dinner table, the set of images may be obtained by performing an image search, for example on the Internet, with the search term ‘dinner table layout’. This step may, in some examples, also be performed autonomously by a computer. Accordingly, in some examples, the training of the machine learning model may be made autonomous or semi-autonomous. The cost value label may be continuous or may in some examples be one of a plurality of discrete values, for example, a binary value. For example, a set of training data representing a tidy arrangement of objects (thereby providing a ‘positive’ training example) may have a cost value label of 0, whereas a set of training data representing an untidy arrangement of objects (thereby providing a ‘negative’ training example) may have a cost value label of 1. In some examples, the obtained training data set may not include such ‘negative’ examples and may for example only include ‘positive’ examples. In some examples, the cost value label may be implicit in the sense that inclusion of an arrangement into a group of ‘positive’ examples may indicate that the associated cost value label is to be low (e.g. 0). In some examples, ‘negative’ or otherwise ‘background’ examples may be generated during the training. For example, negative or background arrangements may be generated by modifying the relative poses between objects in a given ‘positive’ example arrangement, and these negative or background arrangements may be assigned a relatively large cost value label (e.g. 1), and included into the obtained training data set. Accordingly, in some examples, the method may comprise determining data representing an arrangement of objects different from one or more of the arrangements of objects in the obtained training data set (thereby providing ‘negative’ or ‘background’ arrangements); and including the determined data, and an associated cost value label that indicates the arrangement of objects represented by the data differs from an optimum arrangement, into the training data set. As mentioned, the machine learning model may be a graph neural network, and the training data set may accordingly comprise a plurality of sets of graph data. Having the training data sets comprising graph data of the arrangements may allow for such ‘negative’ or ‘background’ examples to be efficiently generated.

According to a second aspect of the invention, there is provided a method of training a machine learning model to provide a cost function for determining an arrangement of objects, the method comprising: obtaining a training data set, the training data set comprising a plurality of sets of data, each set of data representing an arrangement of objects in a scene and comprising data representing the objects and data representing the relative pose between the objects, wherein each set of data representing an arrangement of objects is associated with a cost value label indicative of the extent to which the arrangement differs from an optimum arrangement of the objects; and training the machine learning model, based on the training data set, to learn a cost function which, based on an input of data representing an arrangement of objects, outputs a cost value indicative of an extent to which the arrangement differs from an optimum arrangement. This may allow for the trained machine learning model to be provided.

Optionally, the method may comprise determining data representing an arrangement of objects different from one or more of the arrangements of objects in the obtained training data set; and including the determined data, and an associated cost value label that indicates the arrangement of objects represented by the data differs from an optimum arrangement, into the training data set. This may allow, for example, for ‘negative’ or otherwise ‘background’ examples to be generated during the training.

Optionally, the training data set comprises a plurality of sets of graph data, each set of graph data representing a graph representing an arrangement of objects in a scene, the graph comprising nodes and edges connecting nodes, wherein each node represents a respective object and each edge represents a relative pose between two objects represented by two nodes that the edge connects, and wherein the machine learning model is a graph neural network. As has been described, graph neural networks may be well suited to learning object-object relations, and hence this may provide for a resource efficient and/or reliable way to train a machine learning model. Moreover, the graph data may provide a resource efficient way to generate ‘negative’ example used in the training of the machine learning model. For example, as mentioned above, negative training examples could be provided by generating counter example graphs (e.g. by modifying the graphs of one or more of the provided positive example arrangements), which may be more resource efficient than generating realistic images of untidy scenes, for example. Alternatively or additionally, this may help allow for the training to be conducted without human supervision or environment interaction, for example in an autonomous and/or semi-autonomous way.

According to a third aspect of the invention, there is provided an apparatus configured to perform the method according to the first aspect and/or the second aspect.

Optionally, the apparatus is a robot configured to move one or more of the objects of the scene. This may help to provide a robot that can autonomously or semi-autonomously tidy objects of the scene.

According to a fourth aspect of the invention, there is provided a computer program comprising instructions which, when executed by a computer, cause the computer to perform the method according to the first aspect and/or the second aspect. In some examples, the computer program may be stored on a non-transitory computer readable medium. According, according to a fifth aspect of the invention, there is provided a computer readable storage medium storing instructions which, when executed by a computer, cause the computer to perform the method according to the first aspect and/or the second aspect. The computer may, for example, be part of a robot, or may be a remote server or other computing device, for example which communicates with a robot.

Further features will become apparent from the following description, which is made with reference to the accompanying drawings.

### BRIEF DESCRIPTION OF THE DRAWINGS

FIG. 1 is a flow chart illustrating a method according to an example;

FIG. 2 is a schematic diagram illustrating a first arrangement of objects of a scene, according to an example;

FIG. 3 is a schematic diagram illustrating a graphical representation of an arrangement of objects according to an example;

FIG. 4 is a schematic diagram illustrating a flow between functional blocks according to an example;

FIG. 5 is a schematic diagram illustrating a flow between functional blocks according to an example;

FIG. 6 is a graph illustrating a plot of a projection of a cost function, according to an example;

FIG. 7 is a schematic diagram illustrating a second arrangement of objects of a scene, according to an example;

FIG. 8 is a schematic diagram illustrating a flow between functional blocks according to an example;

FIG. 9A is a schematic diagram illustrating a plot of an example cost function for an example set of objects;

FIG. 9B is a schematic diagram illustrating a plot of an example further cost function;

FIG. 9C is a schematic diagram illustrating a plot of a combination of the example cost function and the example further cost function;

FIG. 10 is a flow chart illustrating a method according to an example; and

FIG. 11 is a schematic block diagram illustrating an apparatus according to an example.

### DETAILED DESCRIPTION

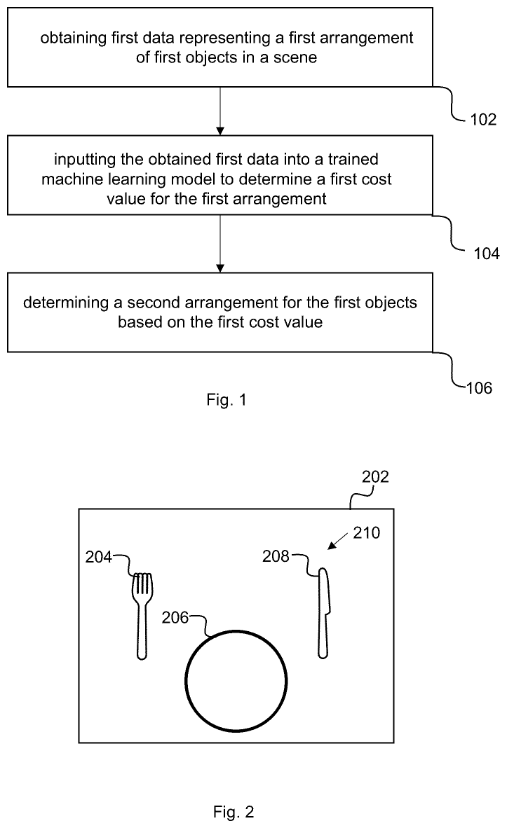

Referring to FIG. 1 there is illustrated an example of a method of determining an arrangement for objects. In broad overview, and with reference to the example arrangement of objects depicted in FIG. 2, the method comprises:
in step 102, obtaining first data representing a first arrangement 210 of first objects 204 in a scene, the first data comprising data representing the first objects and data representing the relative pose between the first objects;
in step 104, inputting the obtained first data into a trained machine learning model to determine a first cost value for the first arrangement, the trained machine learning model having been trained to provide a cost function which, based on an input of data representing an arrangement of objects, outputs a cost value indicative of an extent to which the arrangement differs from an optimum arrangement, wherein the first cost value is indicative of an extent to which the first arrangement differs from an optimum arrangement of the first objects according to the cost function; and
in step 106, determining a second arrangement for the first objects based on the first cost value.

Determining the second arrangement for the first objects, for example an arrangement into which a robot is to tidy the first objects, based on a cost value indicative of an extent to which the first arrangement differs from an optimum arrangement (e.g. output from a learned ‘tidiness’ cost function of the machine learning model), may allow a flexible determination of the second arrangement.

Referring to FIG. 2, there is illustrated an example scene 202. The scene 202 comprises a first arrangement 210 of first objects 204, 206, 208. In this example, the objects are a knife 208, a fork 204, and a plate 206. As humans, we are able to look at the scene 202 and instinctively appreciate that the first arrangement 210 of objects is not ‘correct’ or ‘tidy’. The arrangement 210 is not ‘tidy’ in the sense that the plate 206 is out of alignment with the fork 204 and knife 208. Further, we are able to instinctively appreciate that, to create a tidy or correct arrangement, the plate should be moved up in the sense of FIG. 2 to be placed in the centre line between the knife 208 and fork 204. However, determining whether or the extent to which the arrangement 210 is not ‘correct’ or ‘tidy’, as well as determining what would constitute a more correct or tidier arrangement of the objects 204-208, is challenging for robots or computers to do, as this may depend on a complex mixture of factors. As a first step, data representing the first arrangement 210 of objects 204-208 in the scene 202, and hence on the basis of which computations may be performed, is obtained.

As mentioned, the obtained first data comprises data representing the first objects 204-208 and data representing the relative pose between the first objects 204-208. In some examples, data representing the first objects may comprise an identifier for each object 204-208 and/or information describing the object 204-208. In some examples, the relative pose may comprise the relative distance between each object 204-208 and each other object 204-208 of the first arrangement. In some examples, the relative pose may comprise the relative orientation of each object 204-208 and each other object 204-208 of the first arrangement 210. This first data may provide for the first arrangement 210 to be appropriately and accurately represented.

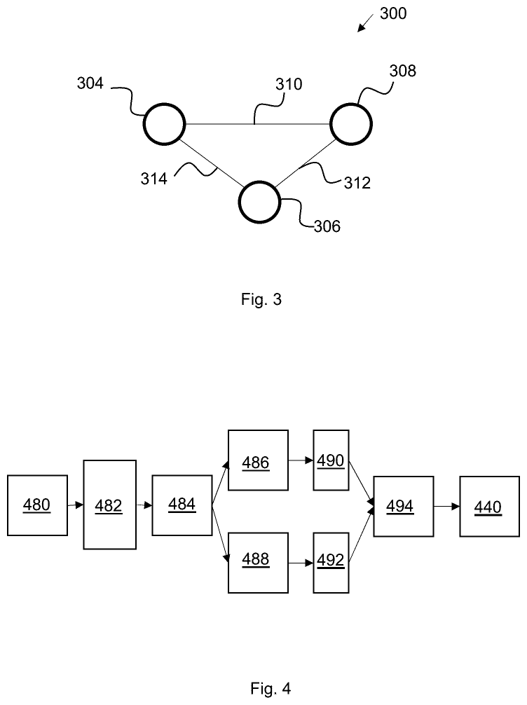

In some examples, the obtained first data comprises first graph data representing a graph, which in turn represents the first arrangement of objects in the scene. For example, referring to FIG. 3, there is illustrated a graph 300 representing the first arrangement 210 of objects in the scene 202. The graph comprising nodes 304, 306, 308 and edges 310, 312, 314 connecting the nodes 304, 306, 308. Each node 304-308 represents a respective object 204-208 and each edge 310-314 represents a relative pose between two objects represented by two nodes that the edge connects. For example, a first edge 310 connects the node 304 representing the fork 204 and the node 308 representing the knife 206 and represents a relative pose between them; a second edge 312 connects the node 308 representing the knife and the node 306 representing the plate 206 and represents a relative pose between them, and a third edge connects the node 306 representing the plate 206 and the node 304 representing the fork 304 and represents a relative pose between them. The inventors have appreciated that such a graph representation may be an efficient way of representing an arrangement of objects, in particular for the task of determining a tidier or otherwise more ‘correct’ arrangement of those objects. The first graph data may comprise, for example, data representing the graph and which is suitable for input to a graph neural network. For example, the first graph data may comprise a list of the nodes and a list of the edges of the graph 300.

As described in more detail below, the trained machine learning model may be a trained graph neural network. The inventors have appreciated that a graph neural network may be well suited to learning object-object relations, and that accordingly, providing the obtained first data as the first graph data, and using the graph neural network as the machine learning model, may provide for an efficient and/or reliable determination of the second arrangement. In some examples, the first graph data may comprise: for each node of the graph a semantic vector representative of the respective object; and/or for each edge of the graph a relative pose vector representative of the relative pose between two objects represented by two nodes that the edge connects.

In some examples, the method may comprise generating the first data. For example, in some examples the method may comprise obtaining image data representing an image of the objects 204-206 of the scene 202 in the first arrangement 210; and generating the first data based on the obtained image data. This may allow for the determination of a more optimum arrangement to be based on e.g. a single image of the scene. This may allow for the arrangement to be determined in a resource efficient way. In some examples, the method may comprise generating the first graph data, which may comprise: generating the semantic vector for each of the one or more objects; and/or generating a pose vector for each of the one or more objects, the pose vector representing a pose of each of the objects, and determining the relative pose vector for each edge based on the pose vector for the two objects of the two respective nodes that the edge connects. This may allow for the semantic vector and/or pose vectors to be generated from the obtained image. This may help allow for the method to be implemented autonomously.

Referring to FIG. 4, there is illustrated an example flow between functional blocks in order to determine the first data, according to an example. In some examples, one or more of the steps performed by one or more of the functional blocks may form part of the method described above with reference to FIG. 1. Referring now to FIG. 4, an image 480 of the scene 202, for example captured by a camera (not shown) is obtained. The image 480 is input into an object detector 482. For example, the object detector 482 may be configured to detect each of the objects 204-208 in the image 480 of the scene 202, and output, for each object, a class of the object (e.g. for the fork 204 the output class maybe “fork”). The object detector 482 may also, for example, for each detected object output a segmentation mask (e.g. a mask consisting of the pixels of the image 480 that are determined to represent the detected object) and a bounding box (e.g. the coordinates of a box that bounds the detected object). For example, the object detector 482 may comprise a pretrained Mask Region-based Convolutional Neural Network (R-CNN). Portions of the output 484 of the object detector 482 are then provided to a pose estimator 486 and a semantic embedding generator 488.

The pose estimator 486 estimates a pose 490 of each detected object 204-208. For example, the pose estimator 486 takes as input, for each detected object 204-208, the segmentation mask. The pose estimator 486 estimates the position of the object by determining the centre of mass of all of the pixels of the segmentation mask for the object. The pose estimator 486 estimates the orientation of the object by (1) using the segmentation mask to determine the direction in which the object is longest and hence determine the principle axis of the object; and (2) using a skew of the pixels in the segmentation mask to determine which direction along the principle axis points to a head of the detected object. The pose estimator 486 may output, for each object, as the pose 490 of the detected object, a concatenation of a vector defining the determined position of the object and a vector defining the determined orientation of the object.

The semantic embedding generator 488 generates a semantic embedding for each detected object 204-208. For example, the semantic embedding generator 488 takes as input, for each detected object 204-208, the pixels included in the bounding box for each object. For example, the semantic embedding generator 488, for each object, (1) crops the captured image 480 so as to only include the pixels from within the bounding box for that object; and (2) passes the cropped image through a pretrained model to determine a semantic embedding for the object. For example, the pretrained model may comprise a trained neural network configured to output a semantic vector representing the location of that object in semantic vector space, such that, for example, objects of similar types, natures or classes are located in similar regions of the semantic vector space. For example, the pretrained model may be a Contrastive Language-Image Pre-training model, which may represent images as vectors by training on captioned images. Other pretrained models may be used to determine the semantic embedding (vector) for the object. In some examples, prior to passing the cropped image of the object through the pretrained model, the semantic embedding generator 488 may rectify the cropped image to a fixed orientation (e.g. pointing up), e.g. using the object orientation determined by the pose estimator 486. This may provide that an object is given the same semantic embedding regardless of its pose. The semantic embedding generator 488 may, for each object, concatenate the semantic vector determined for the object with the coordinates of the bounding box of the object, in order to preserve information on the size of the object. This concatenation may be output as the semantic embedding 492 for the object.

The semantic embedding 492 and the pose estimation 490 for each object are then provided to a graph generator 494 to generate a graph representing the arrangement of objects of the scene of the image 480. For example, as mentioned above, the nodes of the graph may be the respective semantic embeddings for each object, and each edge of the graph may be the relative pose between the objects represented by the nodes that the edge connects. The graph generator 494 may output first data 440 representing the first arrangement. For example, the graph generator 494 may output first graph data representing the generator graph. For example, the graph generator 494 may output a list of all the nodes of the graph (e.g. a list of semantic vectors for each object of the scene) and a list of all the edges of the graph (e.g. a list of relative pose vectors for each pair of nodes).

It will be appreciated that the method of obtaining the first data 440 representing the first arrangement 210 of objects 204-208 of the scene 202 is an example and that in other examples other methods may be used. Further, it will be appreciated that step 102 of the method described with reference to FIG. 1 may or may not include the example method of obtaining the first data 440 described with reference 4. In any case, in step 102, the first data 440 representing the first arrangement is obtained.

As mentioned, in step 104 of the method described above with reference to FIG. 1, the first cost value is indicative of an extent to which the first arrangement 210 differs from an optimum arrangement of the first objects according to a learned cost function.

Referring to FIG. 6, there is illustrated an example of a projection of a cost function 658 onto a two-dimensional plane. It will be appreciated that the cost function may be a multi-dimensional function, for example depending on the number of variables of the first data representing the arrangement. In the example of FIG. 6, the projection shows the cost value C as a function of a variable D, which may for example represent a position of the plate 206 relative to the fork 204 and the knife 208. In this example, the cost function 658 has a minimum 654 in this projection, and as such the cost value is lowest at the minimum 654. This minimum 654 may, for example, represent the learned optimum position of the plate 206 relative to the fork 204 and the knife 208 in this projection. For example, this minimum 654 may represent an optimum arrangement (at least in this projection) in which the plate 206 is positioned centrally between the fork 204 and the knife 208. It will be appreciated that the cost function may be multi-dimensional and that there may be a global minimum amongst these multiple dimensions that corresponds to a globally optimum arrangement of the objects, according to the learned cost function. Accordingly, the cost value for any given arrangement may be indicative of the extent to which the arrangement differs from this optimum arrangement.

As mentioned, the cost value for a given arrangement is indicative of the extent to which the given arrangement differs from an optimum arrangement according to the learned cost function. The ways in which optimum arrangements (e.g. tidy arrangements) may differ from other arrangements (e.g. non-tidy arrangements) may be learned during training of the machine learning model, for example from example training arrangements provided during training. In the example of FIG. 6, the first arrangement 652 differs from the optimum arrangement 654 in the position of the plate 206. However, it will be appreciated that in other examples, any number of differences may be learned. For example, a scene may include a cup, a kitchen table, and a kitchen counter, where in a first arrangement the cup is placed on the kitchen table. The machine learning model may have been trained based on training data including example arrangements in which a cup is either placed on a table or on a kitchen counter (but not e.g. in mid-air between the table and the counter), and the optimal arrangement according to the learned cost function may be one in which the cup is placed on the kitchen counter. In this case, the machine learning model may learn (and the provided cost function may reflect) that an arrangement in which the cup is in mid-air differs from the optimum arrangement where the cup is on the counter to a greater extent than the arrangement in which the cup is on the table, for example in that where the cup is mid-air the cup is not positioned on/supported by a surface. Accordingly, the cost value output for the arrangement in which the cup is in mid-air between the table and the counter may be relatively large, indicative of the relatively large extent to which the arrangement differs from the optimum arrangement, according to the learned cost function. Using other words, the cost value for a given arrangement may be indicative of (an inverse of) how likely the given arrangement is under a distribution of training arrangements (which distribution is represented by the learned cost function). Arrangements which are similar to positive training arrangements may be relatively ‘likely’ under the distribution and hence have a low cost value whereas arrangements which differ from positive training arrangements may be relatively ‘unlikely’ under the distribution and hence have a high cost value. Accordingly, it will be appreciated that, the lower the cost value, the more closely the arrangement corresponds to an optimum arrangement, according to the cost function. In some examples, the machine learning model may be an energy-based model, and as such the cost value of a given arrangement may be thought of as an energy of the given arrangement, relative to energies of other arrangements.

In some examples, the trained machine learning model may be a trained neural network. For example, the trained neural network may implicitly represent or approximate the cost function. For example, the trained neural network may take as input the first data representing the first arrangement, and output at its output layer the cost value for that arrangement, according to the implicitly represented cost function. In some examples, the trained neural network may comprise a Multi-Layer Perceptron, for example a neural network having multiple hidden layers between the input layer and the output layer.

In some examples, as mentioned, the trained machine learning model may be a trained graph neural network. For example, the trained graph neural network may have been trained to provide a cost function which, based on an input of graph data representing a graph representing an arrangement of objects, outputs a cost value indicative of an extent to which the arrangement differs from an optimum arrangement.

As is known per se, a graph neural network implements an optimizable transformation on attributes of a graph, such as its nodes as edges, while preserving symmetries of the graph. For example, the input to the graph neural network may comprise a list of the node semantic embeddings and a list of the edge relative pose estimates. The graph neural network may perform operations on these lists to provide updated node vectors and updated edge vectors. For example, at each layer of the graph neural network, a given node vector may be updated based on an adjacent node vector and the edge vector of the edge that connects them. For example, given nodes i, j may have respective feature vectors xᵢ, xⱼ, and an edge connecting them may have an edge vector eᵢⱼ. A given layer of the graph neural network may calculate an output feature vector xᵢ′, xⱼ′ for each node. For example, the output feature vector xᵢ′ calculated for node i may be provided by:

$${x}_{i}^{′} = {\sum }_{j} {f}_{θ} ( {x}_{i} \vert {x}_{j} \vert {e}_{i j} ) \qquad ( 1 )$$

where (xᵢ|xⱼ|eᵢⱼ) is the concatenation of the feature vectors xᵢ, xⱼ and eᵢⱼ and f_{θ} is a function that the layer applies to the concatenation. As per equation (1), this function is applied to such a concatenation for each other object j in the graph, and the results of these functions are summed to obtain the output vector xᵢ′ for the node i. This may be conducted for each node of the graph. Accordingly, as the graph passes through the layers of the graph neural network, each node vector and each edge vector is updated so as to reflect the properties of all other nodes and their connections in the graph. A final one or more layers of the graph neural network may comprise, for example, one or more layers that map a vector comprising a concatenation, summation, or other aggregation of all of the resulting node and edge vectors onto a cost value (e.g. a scalar). For example, after passing through the layers of the graph neural network, there may be a node vector at each node of the graph. All of these node vectors may be summed into a single vector (which may be referred to as a graph encoding vector). The graph encoding vector may have the same dimension regardless of how many nodes are in the input graph. The graph encoding vector may then be passed through a multi-layer perceptron neural network, which outputs a scalar, that is, the cost value. The graph encoding vector having the same dimension regardless of how many nodes are in the input graph may allow for the graph neural network to be used to determine the cost value independently of the number of nodes in the input graph. This may allow for a flexible determination of the cost value. The graph neural network may have been trained (e.g. the parameters and/or the functions thereof may have been optimised) so that the graph neural network implicitly represents a cost function which, based on an input of graph data representing a graph representing an arrangement of objects, outputs a cost value indicative of an extent to which the arrangement differs from an optimum arrangement according to the cost function. Accordingly, based on an input of first graph data, the trained graph neural network may output a first cost value indicative of an extent to which the first arrangement differs from an optimum arrangement according to the cost function.

In some examples, the trained machine learning model may be pretrained and obtained, e.g. from storage. In some examples, the method may comprise training a machine learning model to provide the trained machine learning model. In either case, in some examples, the training may comprise obtaining a training data set and training the machine learning model based on the training data set. For example, the training data set may comprise a plurality (e.g. tens or hundreds or thousands) of sets of data. Each set of data may represent an arrangement of objects in a scene and comprise data representing the objects and data representing the relative pose between the objects. For example, each set of data may comprise data similar to the first data representing the first arrangement as described above and/or may be obtained using a similar process to that described above for the first data. For example, in some examples (such as where the machine learning model comprises a graph neural network) each set of data may comprise graph data representing a graph representing the arrangement, for example similarly to as described above for the first graph data. In any case, each set of data representing an arrangement of objects is associated with a cost value label indicative of the extent to which the arrangement differs from an optimum arrangement of the objects.

In some examples, the cost value label may be continuous or may in some examples be one of a plurality of discrete values, for example, a binary value. For example, a set of training data representing a tidy arrangement of objects (thereby providing a ‘positive’ training example) may have a cost value label of 0, whereas a set of training data representing an untidy arrangement of objects (thereby providing a ‘negative’ training example) may have a cost value label of 1. In some examples, the obtained training data set may not include such ‘negative’ examples, and for example the training may comprise training the machine learning model to output a relatively large cost value for arrangements which differ from the ‘positive’ examples provided in the training data set. For example, in some examples, ‘negative’ examples may be generated during the training. For example, arrangements for ‘negative’ examples may be generated by modifying the relative poses between objects in a given ‘positive’ example arrangement, and the arrangements in these ‘negative’ examples may be assigned a relatively large cost value label (e.g. 1), and included into the obtained training data set. Accordingly, in some examples, the method may comprise determining data representing an arrangement of objects different from one or more of the arrangements of objects in the obtained training data set (thereby providing ‘negative’ examples); and including the determined data, and an associated cost value label that indicates the arrangement of objects represented by the data differs from an optimum arrangement, into the training data set.

In some examples, the cost value label may be obtained by a labelling process applied to each set of data (or the images on the basis of which each respective set of data is derived). In some examples, such a labelling process may not be explicitly caried out. For example, in some examples, the training data set may be generated from a set of images showing tidy arrangements of objects. For example, each of the images showing tidy arrangement may be implicitly associated with a relatively low cost value label (e.g. 0). The images may be obtained, for example, by performing an image search (e.g. on the Internet) for tidy arrangements. For example, where the objects are cutlery and crockery of a dinner table, the set of images may be obtained, for example, by performing an image search, for example on the internet, with the search term ‘dinner table layout’. This step may, in some examples, be performed autonomously by a computer. Accordingly, in some examples, the training of the machine learning model may be made autonomous or semi-autonomous.

The machine learning model may be trained, based on the training data set, to provide a cost function which, based on an input of data representing an arrangement of objects, outputs a cost value indicative of an extent to which the arrangement differs from an optimum arrangement. This may allow for the trained machine learning model to be provided. For example, training the machine learning model may comprise optimising parameters of the model so as to minimise a loss (e.g. via a loss function) between cost values predicted by the machine learning model for the arrangements of the training data set and the cost value labels of those arrangements. As mentioned, the machine learning model may be a graph neural network. In this case, the training data set may accordingly comprise a plurality of sets of graph data. During training, the parameters of the graph neural network (e.g. the parameters of the functions thereof) may be optimised to minimise a loss between a cost value that the graph neural network predicts for, and the cost value label associated with, each of a plurality (e.g. tens or hundreds or thousands) of training graphs representing example arrangements of objects. In examples where the ‘negative’ training examples are generated based on the ‘positive’ examples in the obtained training data, the training data set comprising graph data of the arrangements may allow for the ‘negative’ examples to be efficiently generated. For example, altering the edge vectors of graph data of a positive example so as to generate a ‘negative’ (or otherwise ‘background’) examples may be more resource efficient than generating realistic images of untidy scenes.

As mentioned, in some examples, the training data set may not include ‘negative’ examples, and may include ‘positive’ examples (e.g. only positive examples). In these examples, the cost value label may be implicit in the sense that the arrangements have been labelled as having a relatively low cost value (e.g. 0) by their inclusion in the ‘positive’ example training data. In these examples, a loss function (on the basis of which the machine learning model may be optimised) may be based on maximum likelihood estimation. For example, as mentioned, the trained machine learning model may output a cost value, which may be equivalent to an energy E_{θ}(x) of the input arrangement x. In some examples, this energy may be converted to a probability p_{θ}(x), representing a probability of the input arrangement x corresponding to an optimum (e.g. a tidy) arrangement. For example, the probability p_{θ}(x) may be given by:

$${p}_{θ} ( x ) = \frac{{e}^{- {E}_{θ} ( x )}}{{z}_{θ}} \qquad ( 2 )$$

where Z_{θ} is a normalisation term and is given by:

$${Z}_{θ} = {\int }_{x} {e}^{- {E}_{θ} ( x )} d x \qquad ( 3 )$$

which may be computed directly or e.g. estimated by sampling some of the arrangements. In these examples, a loss function L may be derived based on maximum likelihood estimation. The loss function can be used during training of the machine learning model, for example by optimising the parameters of the machine learning model so that the positive training examples (e.g. indexed by i) have a high probability under the model's learned distribution. Maximising the probability is equivalent to minimising the negative log-likelihood. Accordingly, in some examples, the loss function L to be minimised during training of the machine learning model may be provided by:

$$L = {\sum }_{i} - log {p}_{θ} ( {x}_{i} ) \qquad ( 4 )$$

This loss function may help encourage the arrangements of the positive examples to have a high probability (and hence a low-cost value) and all other arrangements to have a lower probability (and hence a higher cost value). Accordingly, in some examples, the cost value for a given arrangement may be indicative of how likely the given arrangement is under the distribution of training arrangements. For example, tidy arrangements may be “likely” under this distribution (because all the training examples are tidy), whereas random arrangements may be “unlikely”, because they are different to all the examples.

In any case, a trained machine learning model may be obtained. As mentioned, the obtained first data 440 is input into the trained machine learning model to determine the first cost value for the first arrangement 210.

Returning to FIG. 1, as mentioned, in step 106, the method comprises determining a second arrangement for the first objects based on the first cost value. The second arrangement may be determined based on the first cost value in a number of different ways, examples of which are described below.

In some examples, determining the second arrangement comprises determining a second arrangement of the first objects 204-208 that has a second cost value indicating that the second arrangement differs from the optimum arrangement to a lesser extent than the first arrangement 210. This may be determined by e.g. gradient descent and/or by sampling the cost function 658 to identify such second arrangements. For example, referring again to FIG. 6, there is indicated the cost value 653 for one such second arrangement and the cost value 654 for another such second arrangement. In each case, the cost value 653, 654 is lower than the cost value 652 for the first arrangement. Accordingly, the second arrangements may each correspond to a tidier arrangement of the first items than the first arrangement 210, for example.

In some examples, determining the second arrangement may comprise determining a gradient of the cost function 658 at the first cost value 652. For example, the trained machine learning model (e.g. the trained neural network, e.g. the trained graph neural network) may be differentiable. Accordingly a gradient of the cost function that the trained machine learning model provides may be determined, for example, with respect to the multiple variables of the cost function. For example, the gradient of the cost function 658 at the first cost value 652 may be determined, and a direction of gradient descent (such as the maximum negative gradient) of the cost function 658 at the first cost value 652 may be identified. This gradient indicates the change in variables of the cost function (e.g. the change in the arrangement of the objects, such as their relative pose) that would cause the largest reduction in cost value. Accordingly, determining the second arrangement may comprise determining the arrangement of objects resulting from the indicated change. For example, this may comprise applying the indicated change (or indicated changes if multiple steps of gradient descent are used) to the first graph, thereby to generate second graph data representing a second graph representing the second arrangement of objects. This second graph may be used e.g. to generate control instructions to cause a robot to move one or more of the objects so as to be in the second arrangement represented by the second graph.

In some examples, gradient descent may be applied only once or a few times to determine a second arrangement that has a cost value 653 that is closer to a minimum of the cost function than the first arrangement. In some examples, gradient descent 656 may be applied iteratively until a second arrangement having a cost value 654 at or near the minimum of the cost function is determined.

In some examples, the gradient descent may comprise added noise at each gradient descent step. For example, in some examples, the gradient descent may be performed using Langevin Dynamics. For example, the arrangement pₜ at a current step of a gradient decent process may be given by:

$${p}_{t} = {p}_{t - 1} - {λ}_{t} ( {∇}_{{p}_{t - 1}} {E}_{θ} ( {p}_{t - 1} ) + {ω}_{t} ) \qquad ( 5 )$$

where pₜ₋₁ is the arrangement in the previous step of the gradient decent process, λₜ is a parameter of the gradient descent, ∇ₚ_{ₜ₋₁}E_{θ}(pₜ₋₁) is the gradient of the cost function at the cost value or energy E_{θ} of the arrangement in the previous step, and ωₜ is a noise term. This noise term ωₜ may help ensure that the gradient descent process concludes at a global minimum rather than a local minimum of the cost function.

In some examples, determining the second arrangement may comprise determining a minimum of the cost function. For example, the second arrangement may be determined as one whose cost value is at or near a minimum (e.g. a local or a global minimum) of the cost function. For example, the minimum may be identified by applying the gradient descent process until the change in arrangements between successive steps is below a threshold.

In some examples, the second arrangement may be determined by sampling the cost function 658 to identify second arrangements which have a lower cost value than the first arrangement 210. For example, this may comprise altering the first data representing the first arrangement so that the objects have an altered arrangement, e.g. different relative poses. This altered first data may be input to the trained machine learning model to determine the cost value for the altered arrangement. This may conducted once or repeated several times. The altered arrangement having the lowest cost value (and a cost value lower than the first cost value) may be determined as the second arrangement.

In some examples, determining the second arrangement may comprise fixing the pose of one or more of the first objects of the first arrangement. For example, an object may be fixed, by constraining its pose to be unchanged in the second arrangement. For example, where determining the second arrangement comprises determining the gradient of the cost function at the first cost value, fixing the pose of one or more of the first objects may comprise constraining the gradient determination to not include the determination of gradients with respect to a change in pose of the one or more fixed objects. In other words, fixing the pose may comprise constraining the gradient determination to only include the determination of gradients with respect to a change in pose of objects whose pose has not been fixed). As another example, where determining the second arrangement comprises sampling the cost function, the alteration of the first arrangement may be constrained so as to not alter the pose of the one or more objects that have been fixed.

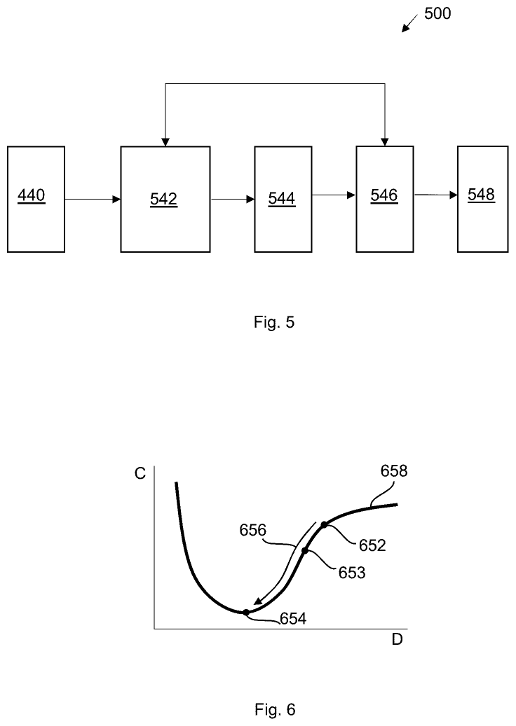

In any case, in step 106 of FIG. 1, a second arrangement for the first objects is determined based on the first cost value. Referring to FIG. 5, there is illustrated schematically a flow between functional blocks 500. In some examples, the steps performed by one or more of the functional blocks may form part of the method described above with reference to FIG. 1. Referring now to FIG. 5, the first data 440 representing the first arrangement 210 is input into the trained machine learning model 542, which outputs the first cost value 544. The first cost value 544 is provided to a second arrangement determiner 546 which determines a second arrangement 548 of the objects based on the first cost value 544. For example, the second arrangement determiner 546 interacts with the trained machine learning model 542 to determine the second arrangement (e.g. by determining a gradient of or sampling the cost function provided thereby, e.g. as described above). The second arrangement determiner 546 outputs the determined second arrangement 548. For example, the output 548 may take the form of second data representing the second arrangement of objects. For example, the output 548 may take the form of second graph data representing a second graph representing the second arrangement of objects.

As mentioned, in step 106 of FIG. 1, a second arrangement for the first objects is determined based on the first cost value. In some examples, the method may further comprise generating control instructions configured to cause a robot to move at least one of the first objects 204-208 towards a pose that the at least one first object 204-208 has in the second arrangement 548. In some examples, the method may comprise providing the control instructions to the robot to cause the robot to move at least one of the first objects 204-208 towards a pose that the at least one first object 204-208 has in the second arrangement. For example, the control instructions may be derived from a difference between the first arrangement (represented by the first data) and the determined second arrangement (represented by the second data). For example, if a particular object 206 has a different pose (e.g. location) in the second arrangement as compared to the first arrangement, the control instructions may comprise instructions to cause a robot to move that particular object 206 to or towards the pose (e.g. location) as per the second arrangement.

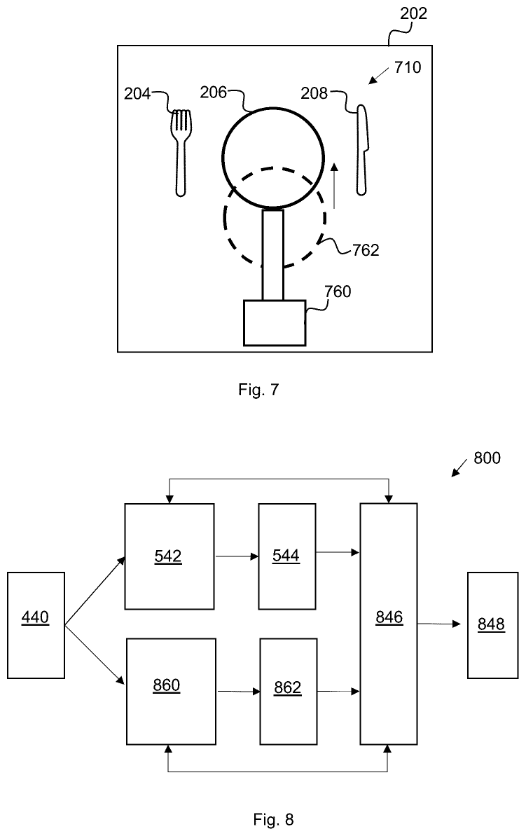

As an example, for the first arrangement 210 of the objects 204-208 shown in FIG. 2, the method may determine that an arrangement in which the plate 206 is placed centrally between the knife 208 and the fork 204 has a cost value lower than the determined first cost value of the first arrangement 210, and hence may be determined as the second arrangement. Referring to FIG. 7, a second arrangement 710 of the objects 204-208 of the scene 202 of FIG. 2 is illustrated. In FIG. 7, the dashed circle 762 represents the position of the plate in the first arrangement 210 of FIG. 2. In this example, a robot 760 has moved the plate 206 so that the objects 204-208 are in the determined second arrangement 710, so that the plate 206 is located centrally between the knife 208 and the fork 204. Accordingly, the objects 204-208 of the scene 202 may be automatically manipulated into a tidy arrangement.

In some of the examples described above, the second arrangement 710 was determined based on the cost function 658, provided by the trained machine learning model, alone. However, this need not necessarily be the case, and indeed determining the second arrangement based on the first cost value may allow for a more flexible determination of the second arrangement (such as allowing further cost functions to be accounted for in the determination of the second arrangement) e.g. as compared to predicting an optimum arrangement for the first objects directly.

Accordingly, in some examples, determining the second arrangement based on the first cost value as per step 106 of FIG. 1 may comprise: combining the first cost value 652 with one or more further cost values for the first arrangement, thereby to generate a first combined cost value. The one or more further cost values may each be determined from a respective further cost function and be indicative of a respective cost of the first arrangement as compared to a respective further optimum according to the respective further cost function. The method may then comprise determining the second arrangement based on the first combined cost value. This may provide that the cost function (e.g. the ‘tidiness’ cost function) is balanced with other costs, such as the time taken to produce a given arrangement and/or the extent to which some arrangements may not be possible because certain objects may not be placed in certain spaces. This may provide for flexible and practical determination of the second arrangement, and hence e.g. may provide for a flexible and practical implementation of a tidying robot.

As one example, the one or more further cost values may comprise an occupancy cost value indicative of an extent to which one or more of the first objects in the first arrangement occupies a space that is not to be occupied. The occupancy cost value may provide for physical practicalities or constraints of the objects 204-208 and/or the scene 202 to be incorporated into the determination of the second arrangement. For example, the occupancy cost value may be determined from an occupancy cost function which maps out in arrangement space cost values indicative of an extent to which one or more of the first objects in the first arrangement occupies a space that is not to be occupied. For example, a space not to be occupied may comprise a space in which a further object, or an immovable or fixed object of the first arrangement, is placed. As another example, a space not to be occupied may comprise a space for which it has been specified, e.g. by a user, that objects are not to be placed. As another example, as space not to be occupied may comprise a space in which an object would not be supported.

As another example, the one or more further cost values may comprise a time cost value indicative of an estimate of a time it would take a robot to interact with one or more of the first objects 204-206 in the first arrangement 201. The time cost value may provide for practicalities and constraints of the arrangements 210, 710 and/or the operation of the robot 760 to be incorporated into the determination of the second arrangement. For example, the time cost value may be determined from a time cost function which maps out in arrangement space cost values indicative of a time that it will take the robot 760 to interact with one or more of the first objects 204-206 in the first arrangement 210. For example, the interaction may comprise reaching (including e.g. locomoting to and/or physically contacting) one or more of the first objects 204-208, engaging (e.g. grabbing or picking up) the one or more objects 204-208 so that the one or more objects can be moved, and/or placing one or more objects 204-208 in a certain position of a certain arrangement. In some examples, the time cost function may be minimum for minimum times. In some examples, the time cost function may reflect a time budget. For example, a robot may be given a certain amount of time to complete a task, and e.g. arrangements which would require more time for the robot to establish than the certain amount of time may be given a high time cost value, for example. Other further cost functions may be used.

Referring to FIG. 8, there is illustrated a flow between functional blocks 800 in the case where the second arrangement is determined based on a combined cost value. The steps performed by one or more of the functional blocks of FIG. 8 may form part of the method described above with reference to FIG. 1. Referring now to FIG. 8, similarly to as described above with reference to FIG. 5, the obtained first data 440 representing the first arrangement 210 is input to the trained machine learning model 542, which outputs the first cost value 544 for the first arrangement 210. However, unlike in FIG. 5, in the example of FIG. 8, the obtained first data 440 representing the first arrangement 210 is also input into a further model 860. In some examples, the further model 860 may take the form of a trained machine learning model providing an implicitly representing the cost function. In other examples, the further model 860 may take the form of the further cost function itself. In any case, the further model 860 provides a further cost function and is configured to, based on an input of data representing an arrangement, output a further cost value 862 indicative of the cost of the first arrangement 210 as compared to a further optimum according to the respective further cost function. For example, where the further cost function is a time cost function representing the time it would take a robot 760 to place a given object 206 of the first arrangement 210 in a certain location, the cost function may be at a minimum for a current location of given object 206 and may, for example, increase with increasing distance from the current location if the given object 206. The first cost value 544 and the further cost value 862 may be provided to a second arrangement determiner 846, which may be configured to, combine the first cost value 544 and the further cost value 862 to generate a first combined cost value. As an example, combining the first cost value 544 and the further cost value 862 may comprise adding them together, and may for example involve performing a weighted sum of the first cost value 544 and the further cost value 862. The second arrangement determiner 846 may then determine a second arrangement for the first objects 204-206 based on the first combined cost value. The determined second arrangement may be output 848 in the form of second data representing the second arrangement, for example second graph data representing a graph representing the second arrangement.

In some examples, determining the second arrangement may comprise determining a second arrangement that has a second combined cost value indicative of the second arrangement differing from a combination of the optimum arrangement and the respective further one or more optimums to a lesser extent that the first arrangement 210. For example, similarly to as described above for the cost function, this second arrangement may be determined by e.g. gradient descent and/or by sampling a combined cost function (e.g. a combination, e.g. a sum or weighted sum, of the cost function and the one or more further cost functions) to identify such second arrangements.

In some examples, determining the second arrangement may comprise determining a gradient of the combined cost function at the first combined cost value, the combined cost function being a combination of the cost function and the one or more further cost functions. For example, the second arrangement determiner 846 may interact with both the trained machine learning model 542 and the further model 860 to determine a gradient of the cost function at the first cost value and a gradient of the further cost function at the further cost value. For example, the respective gradients may be determined in a similar way to as described above. In cases where the cost function and the further cost function are independent of one another (and both dependant on the first data), these two gradients may then be added together (e.g. using a weighted sum) to determine the gradient of the combined cost function at the first combined value.

In some examples, determining the second arrangement may comprise determining a minimum of the combined cost function, the combined cost function being a combination of the cost function and the one or more further cost functions. For example, the second arrangement may be determined as one whose combined cost value is at or near a minimum (e.g. a local or a global minimum) of the combined cost function. The minimum may be identified in a similar way to that described above for the cost function, e.g. using gradient descent (e.g. using Langevin dynamics).

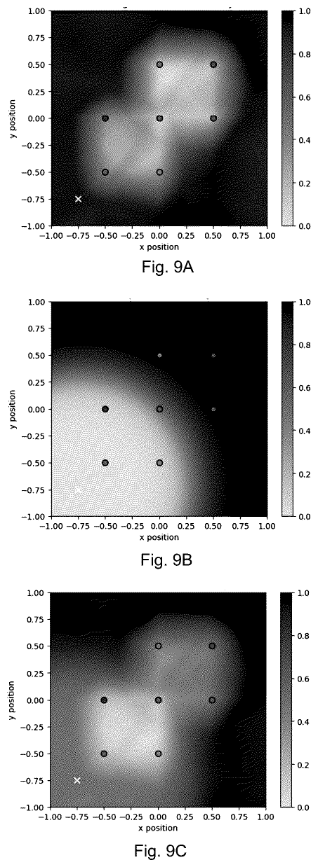

FIGS. 9A to 9C illustrate the combination of a cost function and a further cost function according to a specific example. FIG. 9A illustrates a plot of cost value (intensity) as a function of x,y position of an object (and as such, provides a visual representation of a cost function) according to an example; FIG. 9B illustrates a plot of further cost value (intensity) as a function of x,y, position of the object (and as such, provides a visual representation of a further cost function); and FIG. 9C illustrates a plot of a combination of the first cost value and the further cost value as a function of x, y position of the object (and as such, provides a visual representation of a combined cost function).

In this specific example, and referring to FIG. 9A, each arrangement comprises seven dots (representing objects) arranged in a 2D plane and at the vertices of two squares, where the two squares overlap at one vertex such that only one dot is placed at that verted. In each arrangement, the locations of the seven dots are fixed. Each arrangement also comprises a cross or ‘x’ (representing an object) in the 2D plane. The intensity (in this case darkness) of each pixel in the plot of FIG. 9A represents the cost value output by a trained machine learning model for an input arrangement of the dots and the cross in which the cross is placed at an x, y position corresponding to that pixel. The plot of FIG. 9A therefore visualises the cost function provided by the trained machine learning model, as a function of the x,y position of the cross. The machine learning model has been trained based on training data where positive examples correspond to arrangements where the cross is located within one of the two squares. In other words, a ‘tidy’ scene in the sense of this example is one in which an object represented by the cross is located within one of the two squares of objects represented by the dots. Accordingly, as can be seen in the plot of FIG. 9A, the cost value for the illustrated arrangement (that is, the cost value for a first, current, arrangement of the dots and the cross) is relatively high (as it is outside of the two squares) and the cost values are lowest for arrangements where the cross is located within one of the two squares.

Referring to FIG. 9B, the intensity (in this case darkness) of each pixel in the plot of FIG. 9B represents the further cost value output by a further cost function for an input arrangement of the dots and the cross in which the cross is placed at an x, y position corresponding to that pixel. The plot of FIG. 9B therefore visualises the further cost function provided by the further model, as a function of the x,y position of the cross. In this example, the further cost function is a time cost function, and the further cost value for a given pixel is indicative of a time it would take a robot to move the cross from its current x,y position (as illustrated) to the x,y position of the given pixel. Accordingly, as can be seen in the plot of FIG. 9B, the further cost value for the first arrangement is at a minimum (as the cross is already positioned there), and the cost value increases with increasing distance in the x,y plane of the cross from its initial position. It is noted that since the current position of the cross is closer to the bottom left square, the further cost value is lower within the bottom left square than it is within the top right square.

Referring to FIG. 9C, the intensity (in this case darkness) of each pixel in the plot of FIG. 9C represents the combination (e.g. weighted sum) of the cost value and the further cost value for an input arrangement of the dots and the cross in which the cross is placed at an x, y position corresponding to that pixel. The plot of FIG. 9C therefore visualises the combination of the cost function and the further cost function provided, as a function of the x,y position of the cross. According, as can be seen in the plot of FIG. 9C, the combined cost value for the first arrangement is relatively high (due to the influence of the cost value); the combined cost value for arrangements where the cross is located within the top-right square is also relatively high (due to the influence of the further cost value); but the combined cost value for arrangements where the cross is located in the bottom left square are relatively low (since both the cost values and the further cost values are relatively low here). Accordingly, e.g. using the methods described above such a gradient descent from the combined cost value of the first arrangement, a second arrangement may be determined in which the cross is positioned within the lower left square. For example, control instructions may be generated to control a robot to position the object represented by the cross to be located within the lower left square of objects represented by the dots. Other further cost functions may be used. Further the cost function may be combined with multiple further cost functions. Use of the further cost functions may provide for flexible and practical determination of the second arrangement. Determining the second arrangement based on the first cost value may allow for such a flexible and practical determination to be made (e.g. allow for the incorporation of other costs into the determination), e.g. as compared to predicting the optimum arrangement of the first objects directly.

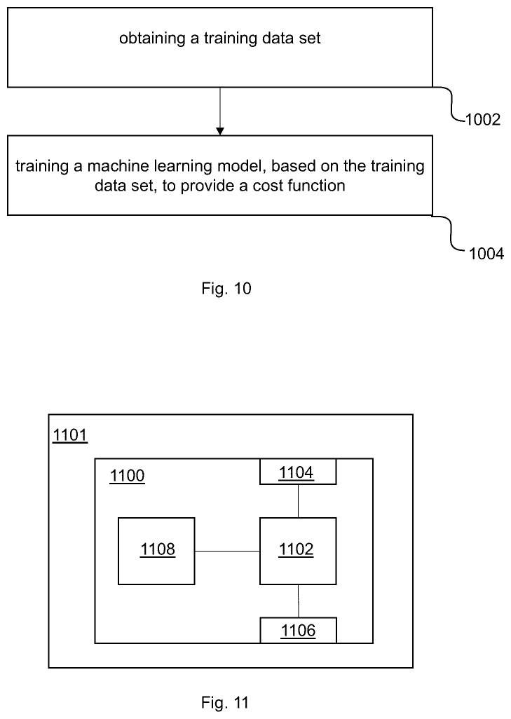

As mentioned, in some examples, the machine learning model may be trained. Referring to FIG. 10, there is illustrated a method of training a machine learning model to provide a cost function for determining an arrangement of objects. The method comprises, in step 1002, obtaining a training data set, the training data set comprising a plurality of sets of data, each set of data representing an arrangement of objects in a scene and comprising data representing the objects and data representing the relative pose between the objects, wherein each set of data representing an arrangement of objects is associated with a cost value label indicative of the extent to which the arrangement differs from an optimum arrangement of the objects. The method comprises, in step 1004, training the machine learning model, based on the training data set, to provide a cost function which, based on an input of data representing an arrangement of objects, outputs a cost value indicative of an extent to which the arrangement differs from an optimum arrangement. In some examples, the training may be the same or similar to the training of any one of the examples described above with reference to FIGS. 1 to 9. In some examples, the trained machine learning model may be used as the trained machine learning model of the method described above with reference to FIG. 1.

Referring to FIG. 11, there is illustrated an apparatus 1100 according to an example. The apparatus 1100 may be configured to perform a method according to any one or more of the examples described above with reference to FIGS. 1 to 10. For example, the apparatus 1100 comprises a processor 1102 (e.g. comprising one or more Graphics Processing Units (GPU)), a memory 1108, an input interface 1104 and an output interface 1106. The memory 1108 may store a computer program comprising instructions which, when executed by the processor, cause the processor to perform the method according to any one of the examples described above with reference to FIGS. 1 to 10. For example, the input interface 1104 may be used to receive training data, and the processor 1102 (e.g. comprising one or more GPUs) may be configured to train a machine learning model based on the training data, for example according to any one of the examples described above with reference to FIGS. 1 to 10. As another example, the input interface 1104 may be used, for example, to receive image data from a camera (not shown) of an image of the scene, and the processor 1102 may be configured generate the first data representing the first arrangement, for example according to any one of the examples described above with reference to FIGS. 1 to 10. The processor may be configured to determine the first cost value for the first arrangement, and determine a second arrangement for the objects based on the first cost value, for example according to any one of the examples described above with reference to FIGS. 1 to 10. The output interface 1106 may be used, for example, to output data representing the second arrangement, or for example, output control instructions to cause a robot to move at least one of the objects towards a pose it has in the second arrangement, for example according to any one of the examples described above with reference to FIGS. 1 to 10. There may be provided a non-transitory computer readable medium storing instructions which, when executed by a computer 1100, cause the computer 1100 to perform the method according to any one of the examples described above with reference to FIGS. 1 to 10.

In some examples, the apparatus 1100 may be a computer. In some examples, the apparatus may be or be part of a remote server 1101. For example, the remote server 1101 may be remote from the robot 760 but may be communicatively coupled to the robot 760 via wired or wireless means. In other examples, the apparatus 1100 may be or may be part of a robot 1101. For example, in some examples the apparatus 1101 may be or be part of a robot (e.g. the robot 760 described above with reference to FIG. 7) configured to move one or more of the objects of the scene. This may help to provide a robot that can autonomously or semi-autonomously tidy objects of the scene.

The above examples are to be understood as illustrative examples. It is to be understood that any feature described in relation to any one example may be used alone, or in combination with other features described, and may also be used in combination with one or more features of any other of the examples, or any combination of any other of the examples. Furthermore, equivalents and modifications not described above may also be employed within the scope of the accompanying claims.

1. A method of determining an arrangement for objects, the method comprising:
obtaining first data representing a first arrangement of first objects in a scene, the first data comprising data representing the first objects and data representing the relative pose between the first objects;
inputting the obtained first data into a trained machine learning model to determine a first cost value for the first arrangement, the trained machine learning model having been trained to provide a cost function which, based on an input of data representing an arrangement of objects, outputs a cost value indicative of an extent to which the arrangement differs from an optimum arrangement, wherein the first cost value is indicative of an extent to which the first arrangement differs from an optimum arrangement of the first objects according to the cost function; and
determining a second arrangement for the first objects based on the first cost value.

2. The method according to claim 1, wherein the method comprises:
generating control instructions configured to cause a robot to move at least one of the first objects towards a pose that the at least one first object has in the second arrangement.

3. The method according to claim 2, wherein the method comprises:
providing the control instructions to the robot to cause the robot to move at least one of the first objects towards a pose that the at least one first object has in the second arrangement.

4. The method according to claim 1, wherein determining the second arrangement comprises determining a second arrangement of the first objects that has a second cost value indicating that the second arrangement differs from the optimum arrangement to a lesser extent that the first arrangement.

5. The method according to claim 1, wherein determining the second arrangement comprises determining a gradient of the cost function at the first cost value.

6. The method according to claim 1, wherein determining the second arrangement comprises determining a minimum of the cost function.

7. The method according to claim 1, wherein determining the second arrangement comprises fixing the pose of one or more of the first objects of the first arrangement.

8. The method according to claim 1, wherein determining the second arrangement based on the first cost value comprises:
combining the first cost value with one or more further cost values for the first arrangement, thereby to generate a first combined cost value, the one or more further cost values each being determined from a respective further cost function and being indicative of a respective cost of the first arrangement as compared to a respective further optimum according to the respective further cost function; and
determining the second arrangement based on the first combined cost value.

9. The method according to claim 8, wherein the one or more further cost values comprise one or more of:
an occupancy cost value indicative of an extent to which one or more of the first objects in the first arrangement occupies a space that is not to be occupied; and
a time cost value indicative of an estimate of a time it would take a robot to interact with one or more of the first objects in the first arrangement.

10. The method according to claim 8, wherein determining the second arrangement comprises:
determining a second arrangement that has a second combined cost value indicative of the second arrangement differing from a combination of the optimum arrangement and the respective further one or more optimums to a lesser extent that the first arrangement; and/or
determining a gradient of a combined cost function at the first combined cost value, the combined cost function being a combination of the cost function and the one or more further cost functions; and/or
determining a minimum of a combined cost function, the combined cost function being a combination of the cost function and the one or more further cost functions.

11. The method according to claim 1, wherein the obtained first data comprises first graph data representing a graph representing the first arrangement of objects in the scene, the graph comprising nodes and edges connecting nodes, wherein each node represents a respective object and each edge represents a relative pose between two objects represented by two nodes that the edge connects, wherein the trained machine learning model is a trained graph neural network having been trained to provide a cost function which, based on an input of graph data representing a graph representing an arrangement of objects, outputs a cost value indicative of an extent to which the arrangement differs from an optimum arrangement.

12. The method according to claim 11, wherein the first graph data comprises:
for each node of the graph a semantic vector representative of the respective object; and/or
for each edge of the graph a relative pose vector representative of the relative pose between two objects represented by two nodes that the edge connects.

13. The method according to claim 1, wherein the method comprises:
obtaining image data representing an image of the objects of the scene in the first arrangement; and
generating the first data based on the obtained image data.

14. The method according to claim 13,
wherein the first graph data comprises:
for each node of the graph a semantic vector representative of the respective object; and/or
for each edge of the graph a relative pose vector representative of the relative pose between two objects represented by two nodes that the edge connects; and
wherein generating the first graph data comprises:
generating the semantic vector for each of the one or more objects; and/or
generating a pose vector for each of the one or more objects, the pose vector representing a pose of each of the objects, and determining the relative pose vector for each edge based on the pose vector for the two objects of the two respective nodes that the edge connects.

15. The method according to claim 1, wherein the method comprises training a machine learning model to provide the trained machine learning model, and wherein the training comprises:
obtaining a training data set, the training data set comprising a plurality of sets of data, each set of data representing an arrangement of objects in a scene and comprising data representing the objects and data representing the relative pose between the objects, wherein each set of data representing an arrangement of objects is associated with a cost value label indicative of the extent to which the arrangement differs from an optimum arrangement of the objects; and
training the machine learning model, based on the training data set, to provide a cost function which, based on an input of data representing an arrangement of objects, outputs a cost value indicative of an extent to which the arrangement differs from an optimum arrangement.

16. A method of training a machine learning model to provide a cost function for determining an arrangement of objects, the method comprising:
obtaining a training data set, the training data set comprising a plurality of sets of data, each set of data representing an arrangement of objects in a scene and comprising data representing the objects and data representing the relative pose between the objects, wherein each set of data representing an arrangement of objects is associated with a cost value label indicative of the extent to which the arrangement differs from an optimum arrangement of the objects; and
training the machine learning model, based on the training data set, to provide a cost function which, based on an input of data representing an arrangement of objects, outputs a cost value indicative of an extent to which the arrangement differs from an optimum arrangement.

17. The method according to claim 16, wherein the training data set comprises a plurality of sets of graph data, each set of graph data representing a graph representing the an arrangement of objects in a scene, the graph comprising nodes and edges connecting nodes, wherein each node represents a respective object and each edge represents a relative pose between two objects represented by two nodes that the edge connects, and wherein the machine learning model is a graph neural network.

18. An apparatus comprising: a processor; and a memory storing a computer program comprising a set of instructions which, when executed by the processor, cause the processor to perform the method according to claim 1.

19. The apparatus according to claim 18, wherein the apparatus is a robot configured to move one or more of the objects of the scene.

20. A non-transitory computer readable medium storing instructions which, when executed by a computer, cause the computer to perform the method according to claim 1.
